(19) United States
(12) Patent Application Publication
(10) Pub. No.: US 2024/0406614 A1
(43) Pub. Date: Dec. 5, 2024

(54) HIGH FIDELITY BONE CONDUCTION SPEAKERS AND HEADPHONES

(71) Applicant: Finnovate Group, LLC, Solana Beach, CA (US)

(72) Inventor: Kari Kristian Rauhala, Solana Beach, CA (US)

(21) Appl. No.: 18/680,890

(22) Filed: May 31, 2024

Related U.S. Application Data
(60) Provisional application No. 63/470,745, filed on Jun. 2, 2023.

(51) Int. Cl. H04R 1/24; H04R 1/10

(52) U.S. Cl. CPC H04R 1/24; H04R 1/1016; H04R 2460/13

(57) ABSTRACT

Audio headphones configured to be worn on a user's head and having a plurality of speakers proximate to or in one or both of the user's ears. The audio headphones include at least one bone conduction speaker configured to be placed adjacently proximate one of the user's ears. The at least one bone conduction speaker is further configured to convey audio in a first frequency range to bones adjacent to the one of the user's ears. The audio headphones further include a least one air conduction speaker configured to be placed in the one of the user's ears. The at least one air conduction speaker is further configured to convey audio in a second frequency range to the one of the user's ears.

### BACKGROUND

Bone conduction (BC) audio delivers sound to a user's ears via vibration of a transducer that couples the vibration via bone conduction near the user's ears to the inner ear bones, which is then interpreted by the user's brain as sound. Air conduction (AC) audio, on the other hand, provides sound waves (via movement or vibration of air) to the user's ear canal where the user's eardrum vibrates and then transfers the vibration to the inner ear to be interpreted as sound.

However, each of the two different audio delivery mechanisms suffer limitations and shortcomings, especially depending on an environment or application in which they are used.

### SUMMARY

This document discloses high fidelity headphones that use multiple speakers at multiple locations of the headphones to optimize the sound experience by the user. In particular, the speakers and headphones use a combination of BC audio and AC audio delivery mechanisms, in various applications including sound delivery, user authentication, haptic feedback, and noise cancelling, to name a few.

In some aspects, audio headphones are configured to be worn on a user's head and having a plurality of speakers proximate to or in one or both of the user's ears. The audio headphones include at least one bone conduction speaker configured to be placed adjacently proximate one of the user's ears. The at least one bone conduction speaker is further configured to convey audio in a first frequency range to bones adjacent to the one of the user's ears. The audio headphones further include a least one air conduction speaker configured to be placed in the one of the user's ears. The at least one air conduction speaker is further configured to convey audio in a second frequency range to the one of the user's ears.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 shows a dual driver bone conduction speaker;

FIG. 2 shows a distributed bone conduction speaker with bone conducting speakers distributed in multiple locations on headphones;

FIG. 3 illustrates the use of air conduction speakers on the outside of a headphone, and bone conduction speakers on the inside of the headphone;

FIG. 4 illustrates a headphone set that combines air conduction, in-ear speakers with a remotely placed bone conduction speaker; and

FIG. 5 shows a headset with a bone conducting audio speaker and/or an air conducting speaker, with light emitting diodes (LEDs) placed on the headphone portion of the headset.

Like reference symbols in the various drawings indicate like elements.

### DETAILED DESCRIPTION

This document describes high fidelity speakers and headphones employing multiple speakers, at multiple locations of the headphones, to optimize the sound experience by the user. In particular, the speakers and headphones use any combination of BC audio and AC audio delivery mechanisms, in various applications including sound delivery, user authentication, haptic feedback, and/or noise cancelling. The headphones can further include strong LEDs for illumination, especially during dark hours.

### Multiple Frequency and Location Spread of BC Speakers.

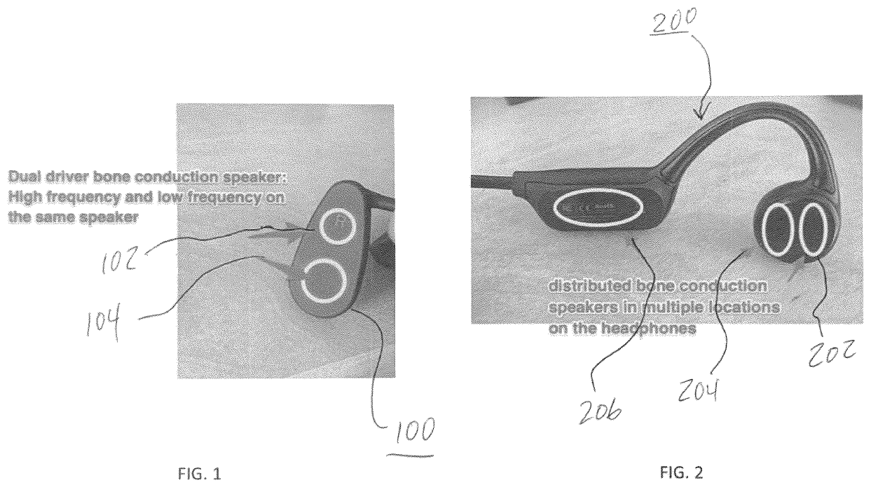

FIG. 1 shows a dual driver bone conduction (BC) speaker 100, having a first BC transducer 102 for conveying high frequency audio signals, and a second BC transducer 104 for conveying low frequency audio signals. Bone conduction speakers use transducers that vibrate. The transducers can be optimized to vibrate more efficiently at certain frequencies. Therefore, when using multiple transducers for difference frequency ranges (low and high as shown in FIG. 1, or low, medium and high as shown in FIG. 2, for example), the sound can more accurate and offer a better vibration delivery and sound experience at those separate frequency ranges.

To improve the bone conduction coupling, a softer BC speaker can be used for bass or lower frequencies, where the softer material is configured to have greater movement, and thus better tuned to vibrate at lower frequencies. Whereas high frequencies are easier to deliver as the vibration movement is less, and therefore preferably use different housing material than a region for the lower frequencies.

Separating the transducers based on frequencies (filtering) and delivering the sound via multiple transducers improves BC audio sound. Additionally, applying different locations for the transducers can further optimize the sound. For example, a high frequency speaker maybe further away from the ear vs the low frequency speaker, etc., as illustrated in FIG. 1. In some implementations, a high frequency BC speaker can be centered within a lower frequency BC speaker. In these implementations, the high frequency and low frequency BC speakers can be isolated by a non-vibrating portion of the housing.

As shown in FIG. 2, in some implementations, headphones 200 can have two or more BC speakers 202, 204, 206 distributed in multiple locations or housings on the headphones 200, such as applying BC audio on opposing sides of the user's ears. Such distribution can further improve the sound by distinctly isolating the frequencies delivered by each BC speaker.

Headphones Having Both Air Conduction Speakers Together with Bone Conduction Speakers

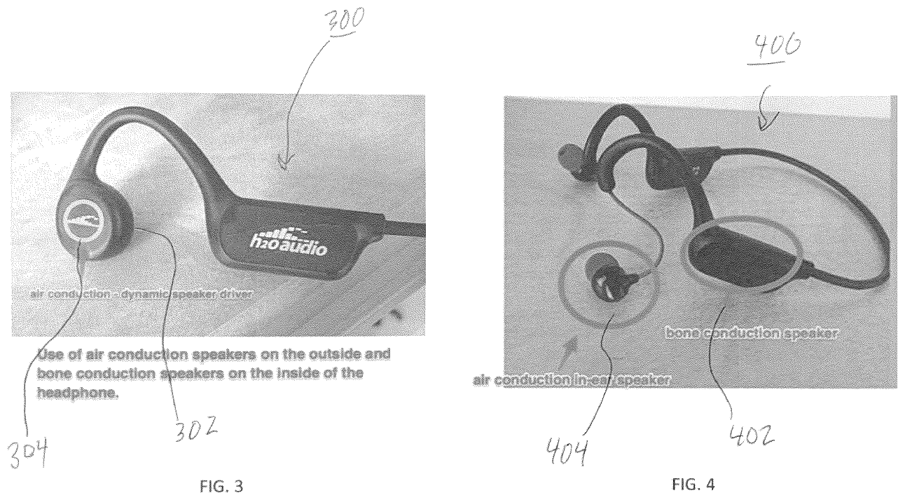

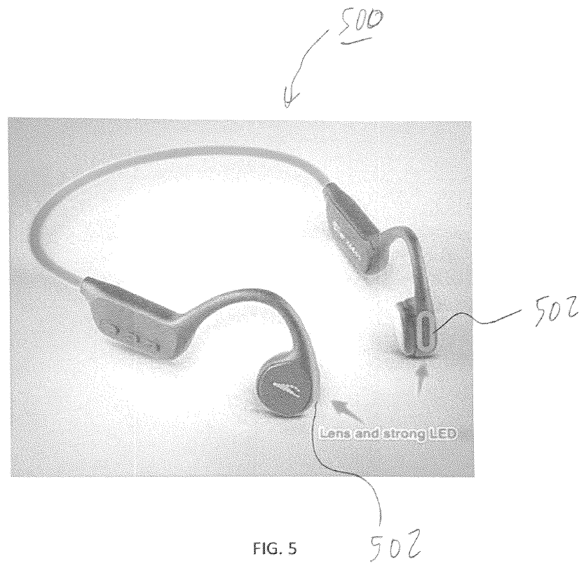

In some implementations, headphones 300, 400 sound can be improved by using both BC speakers 302, 402 and AC speakers 304, 404, which can be configured (i.e., tuned to a particular frequency or range of frequencies) to complement or at least partially augment each other, as illustrated in FIGS. 3 and 4 respectively.

### Sound Balancing Between Speakers

Sound is a personal experience, being that each person's ear structure and skull bone structure are unique. Therefore, the headphones described herein can include a processor, which can be internal or external, that is configured to adjust which speaker combination is used, or to what degree the combination is used. Further, the type of speaker mechanism employed can vary depending on various factors, such as movement by the user, environment of the user, or even temperature of the environment or of the user. The balancing can also be adjustable based on a selected application by the user. As such, the user can manually adjust the output and/or balance of AC versus BC sound.

In some implementations, the user can select and choose which speakers or transducers will be used. For example, the user can tune the headphones—i.e., selecting the balance of which speakers will be used. This can be done via a smartphone app or via a user interface associated with or on the headphones. The user interface can use mechanical buttons, a graphical display, or touch screen.

In other implementations, the headphones may automatically optimize and select the balance of audio delivery between bone and air conduction based on ambient noise, atmospheric pressure (i.e., underwater), etc.

Noise Cancellation with Bone Conduction and Air Conduction Speakers

In some applications, such as at high speeds on a bicycle and in general, the bone conduction (BC) speaker headphones are more subject to the wind noise as the BC speaker does not seal the ear canal and the wind noise enters the ear canal and is heard as the wind pressure vibrates the eardrum. Accordingly, in some implementations, a headphone device employs a microphone and dynamic air conduction (AC) speakers to filter the background noise.

The microphones in the headphones or earbuds listen to outside noise frequencies and emit the exact opposite signal to the AC speakers-effectively to “cancel out” both sets of sounds when the soundwaves collide. This noise cancellation is designed to only remove the constant wind noise while allowing the sound of cars, etc. to be heard, which is typically at higher frequencies, but which noise may occur across all audible frequencies. Thus, the headphones can employ a sound processor to detect sound that is not part of the streaming audio, and then emit an opposite signal of that detected sound for delivery via the AC speakers.

Headphones with User Authentication

The headphones may be linked into or with a user's personal account for i.e., streaming service account. Accordingly, the headphones include a method or mechanism to authenticate the user. This user authentication can be done by fingerprint sensor, audio recognition, audio password, or the like. Once authenticated, user's headphones may download new music files, enable music updates and audio services. Authentication can also be used to access available wireless (i.e., WIFI, cellular, etc.) networks.

### Bone Conduction Speakers as Haptic Feedback

BC speakers can be used for haptic feedback for the user. The haptic feedback can be to alert the user of incoming messages, warnings of upcoming turns in the road. Further the haptic feedback can be used for turn-by-turn navigation, such as left and right turns. For example, the BC speaker on the left side of the headphones will buzz alerting of the left-hand turn coming up, and vice versa. In some implementations, the headphones can include a proximity sensor on either side of the headphones, associated with the left and right side of the user's head, and which can provide a special alert for an object that is in proximity to the user's right or left side, for collision avoidance, for example.

Battery Life Extension with Solar Charging and Removable Batteries.

BC speakers require more power to drive the transducers and therefore consume more battery life verses AC speaker. To offset the power demands, the innovation is to include a solar charging circuit on neckband or headphone frame, etc. to harvest sunlight to charge the battery. On long duration trips where power outlets are no available for normal charging, the headphones may have removable waterproof battery cells that the user can replace.

### Safety Features for Headphones

In some implementations, headphones 500 can include LEDs 502 on neckband of the headphones, on the outside (i.e., rear) of the BC speaker housing, or on any other part of the headphones (see FIG. 5) to alert others, i.e., car drivers, who are approaching from behind.

Headphones with a Built-In Flashlight for Forward Facing Direction.

When running the dark, user can activate (or it is activated by a light detection circuit) a flashlight. The flashlight can include any number of small, but bright, LEDs, and can be positioned on the front facing surface of the speakers allowing the runner to see the trail or road ahead. The flashlight can be perpendicular to the speakers and therefore shine the light forward, as illustrated in FIG. 5.

Although a few embodiments have been described in detail above, other modifications are possible. Other embodiments may be within the scope of the following claims.

1. Audio headphones configured to be worn on a user's head and having a plurality of speakers proximate to or in one or both of the user's ears, the audio headphones comprising:
at least one bone conduction speaker configured to be placed adjacently proximate one of the user's ears, the at least one bone conduction speaker further configured to convey audio in a first frequency range to bones adjacent to the one of the user's ears; and
a least one air conduction speaker configured to be placed in the one of the user's ears, the at least one air conduction speaker further configured to convey audio in a second frequency range to the one of the user's ears.

2. The audio headphones in accordance with claim 1, wherein the first frequency range and the second frequency range are different.

3. The audio headphones in accordance with claim 1, wherein the at least one bone conduction speaker includes two bone conduction speakers, and wherein each of the two bone conduction speakers is configured to convey audio in different portions of the first frequency range.

4. The audio headphones in accordance with claim 3, wherein the different portions of the first frequency range are separate.

5. Audio headphones configured to be worn on a user's head, the audio headphones comprising:
a housing having rechargeable battery and a plurality of speakers for placement proximate to or in one or both of the user's ears, the plurality of speakers comprising:
at least one bone conduction speaker configured to be placed adjacently proximate one of the user's ears, the at least one bone conduction speaker further configured to convey audio in a first frequency range to bones adjacent to the one of the user's ears; and
a least one air conduction speaker configured to be placed in the one of the user's cars, the at least one air conduction speaker further configured to convey audio in a second frequency range to the one of the user's ears.

6. The audio headphones in accordance with claim 5, further comprising one or more light emitting diodes on the housing and connected with the rechargeable battery.

7. The audio headphones in accordance with claim 5, wherein the first frequency range and the second frequency range are different.

8. The audio headphones in accordance with claim 5, wherein the at least one bone conduction speaker includes two bone conduction speakers, and wherein each of the two bone conduction speakers is configured to convey audio in different portions of the first frequency range.

9. The audio headphones in accordance with claim 8, wherein the different portions of the first frequency range are separate.

10. Audio headphones configured to be worn on a user's head, the audio headphones comprising:
a housing having a rechargeable battery and a plurality of speakers for placement proximate to or in each of the user's ears, the plurality of speakers comprising:
at least one bone conduction speaker configured to be placed adjacently proximate one each of the user's ears, the at least one bone conduction speaker further configured to convey audio in a first frequency range to bones adjacent to the one of the user's ears; and
a least one air conduction speaker configured to be placed in each of the user's ears, the at least one air conduction speaker further configured to convey audio in a second frequency range to the one of the user's ears.
